(19) United States
(12) Patent Application Publication
(10) Pub. No.: US 2026/0035639 A1
(43) Pub. Date: Feb. 5, 2026

(54) RATIONAL SOLVENT FORMULATION FOR CURED PHOTORESIST REMOVAL

(71) Applicant: TOKYO OHKA KOGYO CO., LTD., Kawasaki-shi (JP)

(72) Inventors: Yu Geng WU, Hsinchu City (TW); Zhi Jian HONG, Hsinchu City (TW)

(21) Appl. No.: 19/282,818

(22) Filed: Jul. 28, 2025

Related U.S. Application Data
(60) Provisional application No. 63/678,930, filed on Aug. 2, 2024.

(51) Int. Cl. C11D 7/50

(52) U.S. Cl. CPC C11D 7/5013; C11D 7/5022; C11D 2111/22

(57) ABSTRACT

A solvent composition formulated to dissolve cured photoresist on a semiconductor surface comprises about 1 to 30% by mass of at least one alkanolamine; about 10 to 95% by mass of at least one ethylene glycol ether; and zero to about 1% by mass of an N,N-disubstituted hydroxylamine. The N,N-disubstituted hydroxylamine is selected based on the at least one alkanolamine. In particular, the N,N-disubstituted hydroxylamine is alkanol-substituted in any solvent composition comprising N-methyldiethanolamine.

### CROSS-REFERENCE TO RELATED APPLICATIONS

The present application claims priority to U.S. Provisional Application No. 63/678,930 filed with the United States and Trademark Office on Aug. 2, 2024, the entire content of which is incorporated herein by reference.

### BACKGROUND

The present invention relates to rational solvent formulation for cured photoresist removal. Specifically, the present invention relates to a solvent composition.

Semiconductor photolithography is a mature and sophisticated art, which is used to make integrated electronic devices of remarkable sophistication and small feature size. An elementary step in most photolithographic processing is selective photochemical curing of a resinous photoresist layer. The photoresist is applied as a blanket over an entire semiconductor wafer, or die portion of the wafer, and cured via ultraviolet light projected through an optical mask. Via photo-polymerization and/or photo-crosslinking, selected areas of the layer are cured and thereby hardened in the pattern defined by the optical mask. Non-cured portions of the layer (e.g., portions under opaque features of the mask) are washed away with solvent, leaving behind a photo-cured pattern of protected areas.

Subsequent processing may vary from one implementation to another. In some implementations, the semiconductor wafer or die is subjected to dielectric- or semiconductor-etch conditions, which only etch areas not covered by cured photoresist. Alternatively or in addition, the semiconductor wafer or die may be subjected to one or more additive processes, where metals or additional semiconductor material is grown (electrochemically, epitaxially or otherwise), adhering only to the areas not protected by the cured photoresist.

In these and other variants, subsequent processing typically requires removal of all portions of cured photoresist over the surface of the wafer or die. A suitably formulated solvent composition may be used to that effect.

For example, Patent Document 1 (US2020/199,500A) discloses that a cleaning composition for cleaning residue and contaminants from microelectronic devices having same thereon, the cleaning composition containing at least one complexing agent, at least one cleaning additive, at least one pH adjusting agent, water, and at least one oxylamine compound or salt thereof.
Patent Document 1: US2020/199,500A

### SUMMARY

One aspect of this disclosure relates to a solvent composition formulated to dissolve cured photoresist on a semiconductor surface. The solvent composition comprises about 1 to 30% by mass of at least one alkanolamine; about 10 to 95% by mass of at least one ethylene glycol ether; and zero to about 1% by mass of an N,N-disubstituted hydroxylamine. The N,N-disubstituted hydroxylamine is selected based on the at least one alkanolamine. In particular, the N,N-disubstituted hydroxylamine is alkanol-substituted in any solvent composition comprising N-methyldiethanolamine.

This Summary is provided to introduce in simplified form a selection of concepts that are further described in the Detailed Description. This Summary is not intended to identify key features or essential features of the claimed subject matter, nor is it intended to be used to limit the scope of the claimed subject matter. The claimed subject matter is not limited to implementations that solve any or all disadvantages noted in any part of this disclosure.

### BRIEF DESCRIPTION OF THE DRAWINGS

FIG. 1 shows molecular structures of example alkanolamines.

FIG. 2 shows molecular structures of example ethylene glycol ethers.

FIG. 3 shows molecular structures of example N,N-disubstituted hydroxylamines.

FIG. 4 shows molecular structures of additional example compounds not belonging to any of the classes represented in FIG. 1, 2, or 3.

FIG. 5 shows a polymer analogous to cured photoresist, together with a representation of a Hansen solubility parameter (HSP) space, in which the polymer and three different solvents are represented.

FIG. 6 shows aspects of an example evaluation method applicable to the solvent compositions herein.

### DETAILED DESCRIPTION

As noted hereinabove, photolithography employs certain solvent compositions for removal of cured photoresist after a selective-etch and/or selective-addition process. Generally speaking, the solvent compositions are chosen based upon their ability to swell, soften, and/or dissolve the cured photoresist, which comprises one or more cross-linked polymers. In some implementations, the solvent compositions are selected further based on the degree of degradation they may inflict, during cured-photoresist removal, upon various additive structures (e.g., metal or epitaxial semiconductor features) on the semiconductor wafer or die surface. For instance, very aggressive solvent compositions, which may etch or lift off the additive features, are generally undesirable. In some scenarios, effective dissolution of cured photoresist and inactivity toward the additive features are not independent of each other, but coupled in the following manner: a desirable solvent composition may be one that does not appreciably degrade the additive features in the time required for the composition to completely dissolve and wash away the cured photoresist.

Unfortunately, as the art of semiconductor photolithography developed over the years, consideration of the health and ecological effects of the solvent compositions used therein has been insufficient. In particular, N-methyl-2-pyrolidine (NMP), a component of some solvent compositions used for removal of cured photoresist, has been classified recently as a substance of very high concern (SVHC) under the EU's Registration Authorization, and Restriction of Chemicals (REACH) regulations.

This disclosure addresses the above issues and provides further advantages in the field of semiconductor photolithography. This disclosure presents a class of solvent compositions highly effective at removing cured photoresist but comparatively inactive at least towards additive structures comprising copper. Significantly, such solvent compositions comprise no NMP. This disclosure also presents a rational approach toward the formulation of solvent compositions usable for dissolution of cured photoresist, based on a theoretical model of polymer solvation and swelling energetics.

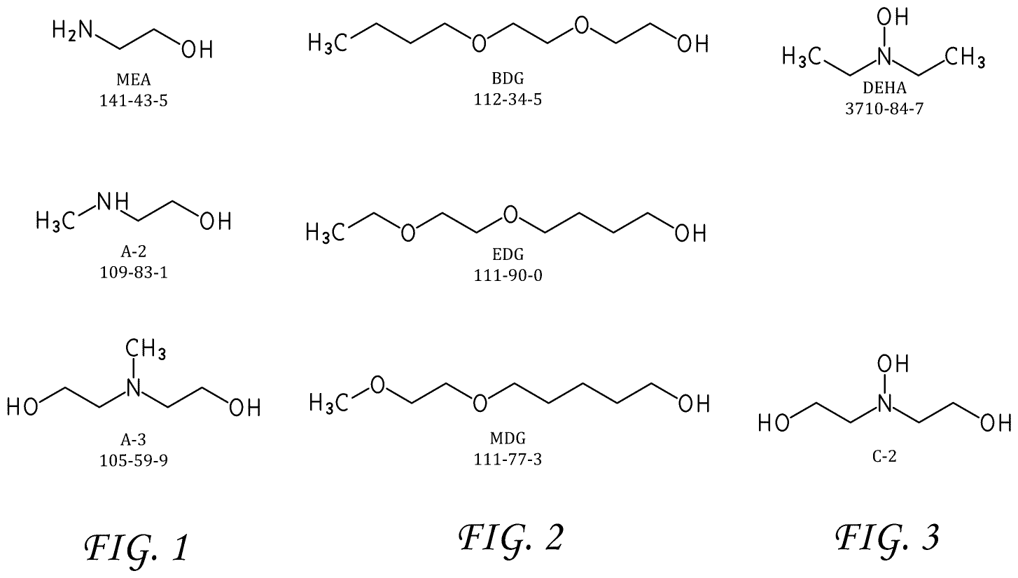

Turning now to the drawings, the inventors herein have investigated certain classes of chemical compounds as components of solvent compositions intended for dissolution of cured photoresist. FIGS. 1-4 show molecular structures of example compounds in the respective classes. These drawings also indicate the Chemical Abstracts Service (CAS) registration number of the illustrated compounds, if available.

FIG. 1 shows molecular structures of example alkanolamines. MEA represents monoethanolamine. A-2 represents N-methylethanolamine. A-3 represents methyldiethanolamine.

FIG. 2 shows molecular structures of example ethylene glycol ethers. BDG represents diethyleneglycol monobutylether. EDG represents diethyleneglycol monoethylether. MDG represents diethyleneglycol monomethylether.

FIG. 3 shows molecular structures of example N,N-disubstituted hydroxylamines. DEHA represents N,N-diethylhydroxylamine. C-2 represents N,N-diethanolhydroxylamine.

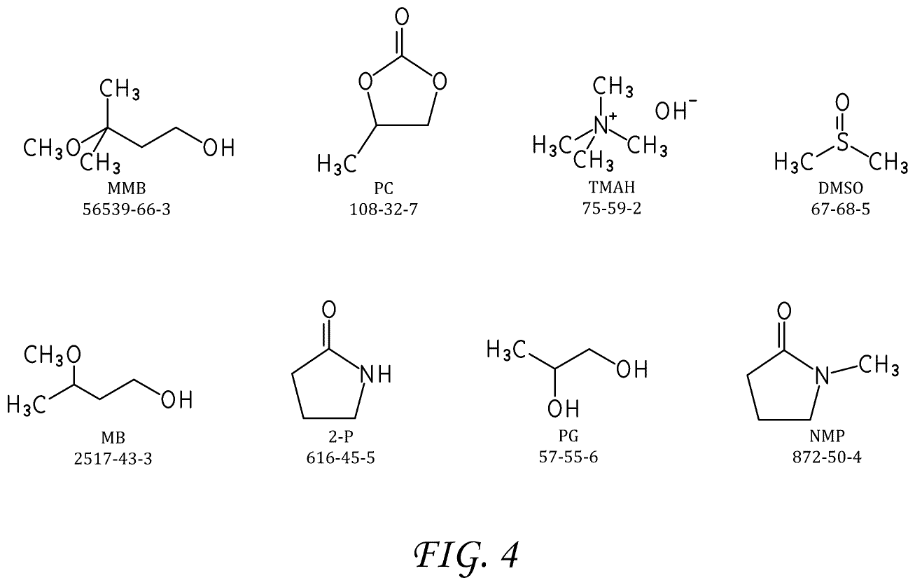

FIG. 4 shows molecular structures of additional example compounds not belonging to any of the classes represented in FIG. 1, 2, or 3. Some of the illustrated compounds are polar, protic compounds. Some of the illustrated compounds are polar, aprotic compounds. Some of the illustrated compounds are alcohols or polyols, and one of the illustrated compounds is a quaternary ammonium hydroxide. MMB represents 3-methoxy-3-methylbutanol. MB represents 3-methoxy-1-butanol. PC represents propylene carbonate. 2-P represents 2-pyrrolidone. PG represents propylene glycol. NMP represents N-methyl-2-pyrrolidone. DMSO represents dimethylsulfoxide. TMAH represents tetramethylammonium hydroxide.

As noted hereinabove, the function of the solvent composition is to swell, soften, and/or dissolve areas of cured photoresist. To initiate a rational search for efficacious solvent compositions, preliminary solvent screening was conducted using a cured photoresist at a thickness of 46 micrometers (μm). Cleaning was enacted in solvent compositions maintained at 70° C. and stirred at 500 revolutions per minute (rpm). In this preliminary screening, mixtures comprising NMEA and a series of different co-solvents revealed the following cleaning times: 8 minutes with a co-solvent comprising 2% TMAH, 76.7% DMSO, and other solvents; 7 minutes with a co-solvent comprising MMB; 7 minutes with a co-solvent comprising MB; >10 minutes with a co-solvent comprising PC; 8 minutes with a co-solvent comprising 2-P; 3.5 minutes with a co-solvent comprising BDG; 3.5 minutes with a co-solvent comprising EDG; and 4 minutes with a co-solvent comprising MDG. As shown by this preliminary data, the best-performing co-solvents were EDG and BDG.

In order to investigate the theoretical basis for these effects, the Hansen solubility parameters (HSPs) of the co-solvents were compared to the corresponding parameters for a polymer model for a first cured photoresist PR1, which is a methacrylate polymer. The first cured photoresist PR1 is commercially available from Tokyo Ohka Kogyo under the product identifier CR-4000.

For context, Hansen solubility parameters are values used to predict the solubility of materials, primarily polymers and solvents, based on intermolecular interactions. Developed by Charles M. Hansen in 1967, HSPs forecast the solubilities of substances via a dispersion-force parameter δD, a polar-force parameter δP, and a hydrogen-bonding parameter δH. Dispersion forces (e.g., the London force) are relatively weak, non-polar interactions present among all molecules. The δD parameter represents the contribution of dispersion forces to overall solubility. Polar forces are due to dipole-dipole interactions among polar molecules. The δP parameter represents the contribution of polar interactions to the solubility. The hydrogen-bonding parameter δH accounts for the hydrogen bonding interactions, which occur when hydrogen is bonded to an electronegative atom such as oxygen, nitrogen, or fluorine. The δH parameter reflects the extent to which hydrogen bonding affects solubility.

HSP parameters may be represented in a three-dimensional space, where each substance is located based on δD, δP, and δH values. The distance between points in this space—the Hansen distance, Ra—can be used to determine the likelihood of one substance dissolving in another. Smaller Ra values indicate better solubility. Generally speaking, HSPs provide a valuable model for understanding and predicting solubility, facilitating the selection of compatible materials in numerous technical fields.

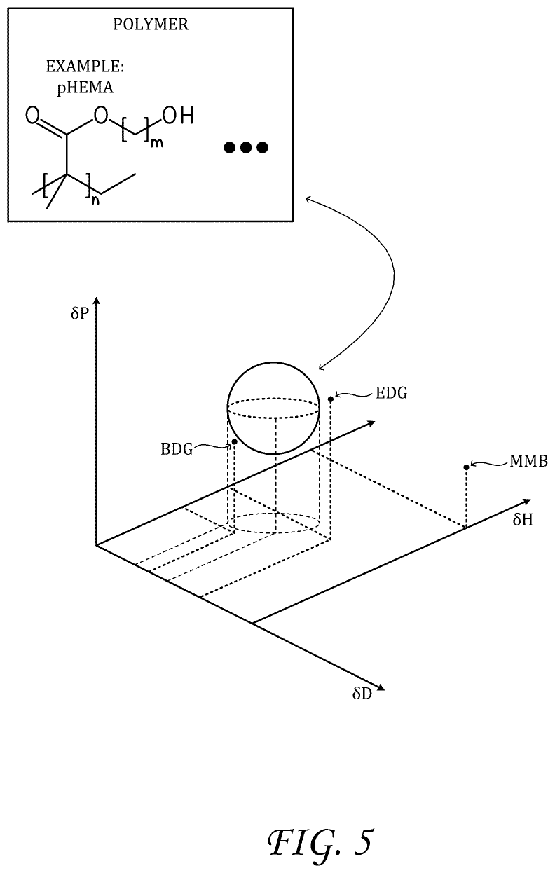

FIG. 5 shows an idealized representation of a polymer analogous to cured photoresist, together with an HSP-space representation in which the polymer and three different solvents are shown. In FIG. 5 polyhydroxyethylmethacrylate (pHEMA) is shown as an example of the polymer used in cured photoresist PR1, however it will be appreciated that different and/or other polymers may be present in cured photoresist, and can be removed by the solvents described herein. It will be appreciated that n and m may take various values in the pHEMA model of FIG. 5. Table 1 reprises the comparison illustrated in FIG. 5. The data indicate that EDG and BDG are close in the parameter space but MMB is far from the target range.

TABLE 1
Comparison of HSP parameters for a polymer analogous
to cured photoresist and candidate solvents.

| chemical | δD | δP | δH |
|---|---|---|---|
| Polymer (cured photoresist) | 17.1 | 5.0 | 12.1 |
| MMB | 18.2 | 12.0 | 9.0 |
| EDG | 16.1 | 9.2 | 12.2 |
| BDG | 16 | 7 | 10.6 |

A solvent exhibiting these HSP values can effectively peel and remove the cured photoresist. Effective peeling and removal of the cured photoresist can occur for the following reasons. Solvents with HSP values near the center points disclosed herein in the HSP coordinate system may have low compatibility with the components of cured photoresists, and little effect of dissolving the cured photoresist. However, specific organic solvents can promote contact between alkaline agents and water in the cured photoresists, facilitating the reaction of the alkaline agent with the terminal carboxy groups of the cured photoresist. The action of such specific organic solvents causes a neutralization reaction between the terminal carboxy groups of the cured photoresist and the alkaline agent, and an aqueous solution is introduced between the cured photoresist and the metal layer, which can cause the cured photoresist to swell. The swollen, cured photoresist can be effectively peeled off from the metal layer. In this way, specific organic solvents with the characteristic HSP values may be capable of removing cured photoresist more efficiently than organic solvents with different HSP values that have the effect of dissolving photoresist. While this mechanism is believed to account for at least some of the efficacy of the disclosed formulations, other mechanisms also may be in part responsible, alternatively or in addition.

Next, an optimization of the EDG: BDG ratio according to the HSPs was attempted. The results are shown in Table 2, where ‘clean time’ refers to the time observed for removal of 46 μm of the first cured photoresist PR1 in a solvent composition maintained at 70° C. and stirred magnetically at 500 rpm.

TABLE 2
HSP parameters and clean-time comparison by BDG:EDG ratio.

| | | | | clean time |
|---|---|---|---|---|
| BDG:EDG ratio | δD | δP | δH | (minutes) |
| 1:3 | 16.075 | 8.65 | 11.8 | 3 |
| (Experimental data 10)*¹ | | | | |
| 2:3 | 16.06 | 8.32 | 11.56 | 3 |
| (Experimental data 11)*² | | | | |
| 1:1 | 16.05 | 8.1 | 11.4 | 3.5 |
| (Experimental data 12)*³ | | | | |
| 3:2 | 16.04 | 7.88 | 11.24 | 4 |
| (Experimental data 13)*⁴ | | | | |
| 3:1 | 16.025 | 7.55 | 11 | 4 |
| (Experimental data 14)*⁵ | | | | |

*¹Refer to “Exp. 10” in Table 3.
*²Refer to “Exp. 11” in Table 3.
*³Refer to “Exp. 12” in Table 12.
*⁴Refer to “Exp. 13” in Table 3.
*⁴Refer to “Exp. 14” in Table 3.

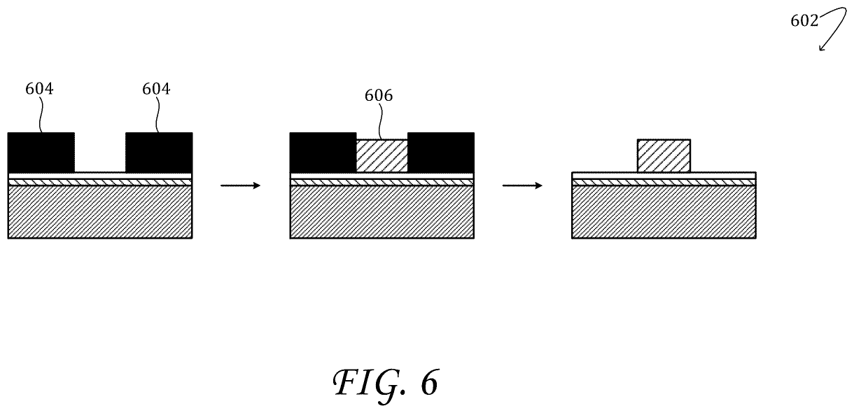

Following the preliminary screening, a more detailed study was undertaken. FIG. 6 shows aspects of an example evaluation method applicable to the solvent compositions herein. The first phase of the evaluation method assesses the rate at which a solvent composition is able to clean cured photoresist from a semiconductor surface 602, such as a wafer or die. First, a silicon (Si) substrate with a thin copper layer (a seed layer for subsequent plating) is provided. Second, a film of photoresist resin is applied at a reproducible thickness (e.g., 46 μm). Third, photolithography is enacted using pre-defined process parameters and an optical mask of a pre-defined configuration. Fourth, using the pattern 604 of cured photoresist as a barrier, copper (Cu) 606 is deposited via bump plating. Fifth, the solvent composition under investigation is employed according to a pre-defined stripping procedure, to remove the cured photoresist. An example stripping procedure is detailed immediately below.

First, the solvent composition is prepared by combining the constituents (e.g., stirring magnetically at 500 rpm and heating to a target temperature of 70° C. Second a wafer or die is placed in the stirred and heated solvent composition and left there for between 2 and 10 minutes. Third, the wafer or die is withdrawn from the solvent composition, rinsed with purified (e.g., distilled) water, and dried in a stream of dry nitrogen, argon, or helium. Fourth, optical microscopy (OM) and/or scanning electron microscopy (SEM) is used to determine the efficacy of removal of the cured photoresist. Optionally, the time intervals to achieve satisfactory cleaning (‘cleaning time’ herein) may be binned as ‘good’ if the cleaning time is less than 4 minutes, ‘intermediate’ if the cleaning time is between 4 and 8 minutes, and ‘poor’ if the cleaning time is longer than 8 minutes.

Next a method of assessing compatibility with Cu-based additive structures will be described. First, physical vapor deposition (PVD) is used to apply a Cu film of a predetermined thickness (e.g., 200 nanometers (nm)) to a Si substrate. Second, the solvent composition is prepared as described above. Third, the wafer is immersed in the stirred and heated solvent composition for 30 to 120 minutes. Fourth, the wafer is rinsed and dried as described above. Fifth, a four-point probe measurement is used to measure the change in sheet resistance, the change in thickness of the Cu adlayer, and the etching rate as a result of immersion in the solvent composition.

Table 3 lists example solvent compositions for removing cured photoresist. The examples with italic reference numbers are comparative examples. The constituents are classified as in FIGS. 1 through 4, and the quantities are given in percent by mass.

Table 4 shows the results of the study. Values in the column headed ‘cleaning time’ have the same meaning as above. Values in the column headed ‘cleaning times’ refer to additional metrics, wherein the first value is the time to remove a 17.8 μm thickness of a second cured photoresist PR2, the second value is the time to remove a 46 μm thickness of a third cured photoresist PR3, the third value is the time to remove a 76 μm thickness of the first cured photoresist PR1, and the fourth value is the time to remove a fourth cured photoresist PR4. The units in these columns are angstroms per minute.

TABLE 4
Results of solvent-composition study.

| | cleaning | cleaning | | |
|---|---|---|---|---|
| | time | times | Cu etch 1 | Cu etch 2 |
| Exp | (minutes) | (minutes) | (Å/minute) | (Å/minute) |
| 1 | | | 53.0 | 43.0 |
| 2 | 7 | | 10.0 | 6.0 |
| 3 | | | 3.0 | 1.0 |
| 4 | 7 | | | |
| 5 | >10 | | | |
| 6 | 3.5 | | | |
| 7 | 3.5 | | | |
| 8 | 4 | | | |
| 9 | 8 | | | |
| 10 | 3 | | | |
| 11 | 3 | | | |
| 12 | 3.5 | | | |
| 13 | 4 | | | |
| 14 | 4 | | <1 | <1 |
| 15 | | | <1 | <1 |
| 16 | 2 | 1, 2.5, 4, 0.25 | <1 | <1 |
| 17 | 2 | | <1 | <1 |
| 18 | 8 | —, —, 10, — | <1 | <1 |
| 19 | 1.5 | —, —, 3, — | <1 | <1 |
| 20 | 2 | 1, 2.5, 4, 0.25 | <1 | <1 |
| 21 | 2 | 1, 2.5, 4, 0.25 | <1 | <1 |

Based on these results, a solvent composition may be formulated to dissolve cured photoresist on a semiconductor surface, such as a wafer or die. The solvent composition may comprise about 1 to 30% by mass of at least one alkanolamine; about 10 to 95% by mass of at least one ethylene glycol ether; and zero to about 1% by mass of an N,N-disubstituted hydroxylamine. The N,N-disubstituted hydroxylamine may be selected based on the at least one alkanolamine, where the N,N-disubstituted hydroxylamine is alkanol-substituted in any solvent composition comprising N-methyldiethanolamine.

As one of the present disclosures, for example, the solvent composition may comprise 0.5% by mass or more and less than 30.5% by mass of at least one alkanolamine, 9.5% by mass or more and less than 95.5% by mass of at least one ethylene glycol ether, and 0% by mass or more and less than 1.5% by mass of N,N-disubstituted hydroxylamine.

As one of the present disclosures, for example, the solvent composition may comprise 1% by mass or more and 30% by mass or less of at least one alkanolamine, 10% by mass or more and 95% by mass or less of at least one ethylene glycol ether, and 0% by mass or more and 1% by mass or less of N,N-disubstituted hydroxylamine.

For example, the content of alkanolamine is preferably 0.5% by mass or more and less than 30.5% by mass. The lower limit thereof is more preferably 1% by mass or more, even more preferably 5% by mass or more, still even more preferably 15% by mass or more, still even more preferably 25% by mass or more.

For example, the content of ethylene glycol ether is preferably 9.5% by mass or more and less than 95.5% by mass. The lower limit thereof may be 10% by mass or more, 20% by mass or more, 30% by mass or more, 40% by mass or more, 50% by mass or more, or 60% by mass or more. The upper limit thereof may be 95% by mass or less, 90% by mass or less, or 85% by mass or less.

For example, the content of an N,N-disubstituted hydroxylamine is preferably 0% by mass or more and less than 1.5% by mass. The lower limit thereof may be more than 0% by mass, or 0.5% by mass or more. The upper limit thereof may be 1% by mass or less.

In some examples the afore-noted zero to about 1% by mass is about 1% by mass. In this case, the afore-noted zero to about 1% by mass may be 0% by mass or more and 1.5% by mass or less. The lower limit in this case may be more than 0% by mass, or 0.5% by mass or more. The upper limit in this case may be less than 1.5% by mass, or 1% by mass or less. In more particular examples the N,N-disubstituted hydroxylamine may comprise N,N-diethanol hydroxylamine, as in Exp17. In some examples the N,N-disubstituted hydroxylamine may function as a corrosion inhibitor. However, any, some, or all of the solvent compositions herein may comprise additional corrosion inhibitors besides. More generally, any, some, or all of the solvent compositions herein may comprise other compounds including compounds from FIG. 4.

The solvent composition according to the present disclosure may further comprise a corrosion inhibitor. Examples of additional corrosion inhibitors are azole compounds. The content of azole compounds is preferably 0.5% by mass or less, more preferably 0.1% by mass or less, still more preferably 0.01% by mass or less, and most preferably 0% by mass. The solvent composition may or may not comprise azole compounds, and it is preferred that it does not comprise azole compounds.

The at least one alkanolamine in the solvent compositions may comprise a primary, secondary, or tertiary amine. In some examples the at least one alkanolamine comprises monoethanolamine, and the N,N-disubstituted hydroxylamine is alkyl-substituted. More particularly, the N,N-disubstituted hydroxylamine may comprise N,N-diethyl hydroxylamine, as in Exp19. In some examples the at least one alkanolamine comprises monoethanolamine, N-methylethanolamine, and/or N-methyldiethanolamine.

From the viewpoint of the above, as one of preferred examples of the present disclosure, the following aspects can be mentioned.

A solvent composition formulated to dissolve cured photoresist on a semiconductor surface, the solvent composition preferably comprises: about 1 to 30% by mass of monoethanolamine; about 10 to 95% by mass of a mixture of ethylene glycol ethers containing diethyleneglycol monobutylether (BDG) and diethyleneglycol monoethylether (EDG); and about 1% by mass of N,N-diethanolhydroxylamine (DEHA).

In this solvent composition, for example, the lower limit of the afore-noted content (about 1 to 30% by mass) of monoethanolamine may be 1% by mass or more, 2% by mass or more, or 3% by mass or more. The afore-noted upper limit of the content (about 1 to 30% by mass) thereof may be 20% by mass or less, 15% by mass or less, 10% by mass or less, or 7% by mass or less.

Furthermore, in this solvent composition, for example, the content of the afore-noted mixture of ethylene glycol ethers (BDG and EDG) may be 10 to 95% by mass. The lower limit thereof may be 40% by mass or more, 60% by mass or more, 80% by mass or more, or 85% by mass or more.

For example, the content of BDG in this solvent composition may be 30 to 50% by mass. For example, the content of EDG in this solvent composition may be 45 to 65% by mass.

For example, the ratio of BDG:EDG in the afore-noted mixture (BDG and EDG) may be 1:1/3 to 1:3, 1:1 to 1:3, or 1:1 to 1:2.5.

Still furthermore, in the solvent composition, the afore-noted about 1 to 30% by mass preferably contains about 5% by mass, and the afore-noted mixture preferably contains about 37% by mass of BDG and about 56% by mass of EDG.

From the viewpoint of the above, as another preferred examples of the present disclosure, the following aspects can be mentioned.

A solvent composition formulated to dissolve cured photoresist on a semiconductor surface preferably comprises: about 1 to 30% by mass of methyldiethanolamine; about 10 to 95% by mass of a mixture of ethylene glycol ethers containing diethyleneglycol monobutylether (BDG) and diethyleneglycol monoethylether (EDG); and about 1% by mass of N,N-diethanolhydroxylamine (DEHA).

In this solvent composition, for example, the lower limit of the afore-noted content (about 1 to 30% by mass) of methyldiethanolamine may be 1% by mass or more, 2% by mass or more, or 3% by mass or more. The upper limit of the afore-noted content (about 1 to 30% by mass) thereof may be 20% by mass or less, 15% by mass or less, or 10% by mass or less, or 7% by mass or less.

Furthermore, in this solvent composition, for example, the content of the afore-noted mixture of ethylene glycol ethers (BDG and EDG) may be 10 to 95% by mass. The lower limit thereof may be 40% by mass or more, 60% by mass or more, 80% by mass or more, or 85% by mass or more.

For example, the content of BDG in this solvent composition may be 30 to 50% by mass. For example, the content of EDG in this solvent composition may be 45 to 65% by mass.

For example, the ratio of BDG:EDG in the afore-noted mixture (BDG and EDG) may be 1:1/3 to 1:3, 1:1 to 1:3, or 1:1 to 2.5.

Still furthermore, in this solvent composition, the afore-noted about 1 to 30% by mass preferably contains about 5% by mass, and the afore-noted mixture preferably contains about 37% by mass of BDG and about 56% by mass of EDG.

From the viewpoint of the above, as further preferred examples of the present disclosure, the following aspects can be mentioned.

A solvent composition formulated to dissolve cured photoresist on a semiconductor surface preferably comprises: about 5% by mass of methyldiethanolamine; about 94% by mass of a mixture of ethylene glycol ethers containing diethyleneglycol monobutylether (BDG) and diethyleneglycol monoethylether (EDG); and about 1% by mass of N,N-diethylhydroxylamine (DEHA).

In this solvent composition, for example, the afore-noted content (about 5% by mass) may be 4.5% by mass or more and less than 5.5% by mass.

Furthermore, in this solvent composition, for example, the content (about 94% by mass) of the afore-noted mixture of ethylene glycol ethers (BDG and EDG) may be 93.5% by mass or more and less than 95.5% by mass.

For example, the content of BDG in this solvent composition may be 30 to 50% by mass. For example, the content of EDG in this solvent composition may be 45% by mass or more and 65% by mass or less.

For example, the ratio of BDG:EDG in the afore-noted mixture (BDG and EDG) may be 1:1/3 to 1:3, 1:1 to 1:3, or 1:1 to 1:2.5.

Still furthermore, in this solvent composition, the afore-noted mixture of ethylene glycol ethers preferably contains about 40% by mass of diethyleneglycol monobutylether (BDG) and about 60% by mass of diethyleneglycol monoethylether (EDG).

In some examples the afore-noted zero to about 1% by mass is 0% by mass, as in Exp 1 through 15. In some examples the at least one ethylene glycol ether may be protic. In some examples the at least one ethylene glycol ether may be an alcohol. In some examples the at least one ethylene glycol ether comprises 3-methoxy-3-methylbutanol, diethyleneglycol monobutylether, diethyleneglycol monoethylether, and/or diethyleneglycol monomethylether.

In some example the at least one alkanolamine and the at least one ethylene glycol ether are selected based on a computed solubility of the cured photoresist in the solvent composition. Here the solubility may be computed according to a model of dispersion forces, dipolar forces, and hydrogen bonding between the solvent system and the cured photoresist. In a variant of this approach, the only solvent modeled in this way may be the ethylene glycol ether component. In some examples the model is an HSP model. In some instances where an HSP model is used, the parameters of the model may include δD from 14 to 20, δP from 4 to 10, and δH from 7 to 15.

No aspect of this disclosure should be interpreted in a limiting sense, for numerous variations, extensions, and omissions are equally envisaged. For instance, although the foregoing description refers specifically to removal of cured photoresist from semiconductor wafer and dies, the solutions herein are equally applicable to semiconductor devices, panels (e.g., panel-level packages), carriers, and the like.

There are several alternatives to HSPs for predicting solubility based on energetics. The Hildebrand solubility parameter (δ) is a measure of the cohesive energy density of a substance; it is defined as the square root of the cohesive energy density. Regular solution theory uses the Hildebrand parameter and assumes that mixing occurs without any change in the volume or energy of the mixture. Flory-Huggins solution theory extends the regular solution theory to polymers, accounting for the size difference between solvent and polymer molecules. Universal quasi-chemical functional-group activity coefficients (UNIFAC) estimates activity coefficients using group contribution methods, where molecules are divided into functional groups with known interaction parameters. The conductor-like screening model for real Solvents (COSMO-RS) is a quantum chemistry-based method and uses the dielectric continuum model to calculate the solvation free energy of molecules, including those involving hydrogen bonding. Kamlet-Taft Parameters include α (hydrogen bond donating ability), β (hydrogen bond accepting ability), and π* (polarity/polarizability). These alternatives provide various approaches to predicting solubility and miscibility, each with its strengths and limitations relevant for different types of substances and mixtures.

This disclosure is presented by way of example and with reference to the attached drawing figures. Components, process steps, and other elements that may be substantially the same in one or more of the figures are identified coordinately and described with minimal repetition. It will be noted, however, that elements identified coordinately may also differ to some degree. It will be further noted that the figures are schematic and generally not drawn to scale. Rather, the various drawing scales, aspect ratios, and numbers of components shown in the figures may be purposely distorted to make certain features or relationships easier to see.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed. In some examples the terms ‘about’ and ‘approximately’, as applied to a numeric value x, expand x to include any value in a range between 0.9x and 1.1x; in some examples these terms expand x to include any value in a range between 0.95x and 1.05x.

The subject matter of the present disclosure includes all novel and non-obvious combinations and sub-combinations of the various processes, systems and configurations, and other features, functions, acts, and/or properties disclosed herein, as well as any and all equivalents thereof. Furthermore, unless otherwise specified, the configurations and parameters disclosed in the present disclosures can be combined in any manner. Additionally, unless otherwise specified, the upper and lower limits of the values disclosed in the present disclosures can be combined in any manner.

### REFERENCE CHARACTER LIST

PR1: Cured photoresist
PR2: Cured photoresist,
PR3: Cured photoresist
PR4: Cured photoresist
602: Semiconductor surface
604: Pattern
606: Copper (Cu)

1. A solvent composition formulated to dissolve cured photoresist on a semiconductor surface, the solvent composition comprising:
about 1 to 30% by mass of at least one alkanolamine;
about 10 to 95% by mass of at least one ethylene glycol ether; and
zero to about 1% by mass of an N,N-disubstituted hydroxylamine selected based on the at least one alkanolamine, where the N,N-disubstituted hydroxylamine is alkanol-substituted in any solvent composition comprising N-methyldiethanolamine.

2. The solvent composition of claim 1 wherein the zero to about 1% by mass is about 1% by mass.

3. The solvent composition of claim 2 wherein the N,N-disubstituted hydroxylamine comprises N,N-diethanol hydroxylamine.

4. The solvent composition of claim 1 wherein the at least one alkanolamine comprises monoethanolamine, and wherein the N,N-disubstituted hydroxylamine is alkyl-substituted.

5. The solvent composition of claim 4 wherein the N,N-disubstituted hydroxylamine comprises N,N-diethyl hydroxylamine.

6. The solvent composition of claim 1 wherein the zero to about 1% by mass is 0% by mass.

7. The solvent composition of claim 1 wherein the at least one ethylene glycol ether is an alcohol.

8. The solvent composition of claim 1 wherein the at least one alkanolamine comprises monoethanolamine, N-methylethanolamine, and/or N-methyldiethanolamine.

9. The solvent composition of claim 1 wherein the at least one ethylene glycol ether comprises 3-methoxy-3-methylbutanol, diethyleneglycol monobutylether, diethyleneglycol monoethylether, and/or diethyleneglycol monomethylether.

10. The solvent composition of claim 1 wherein the at least one alkanolamine and the at least one ethylene glycol ether are selected based on a computed solubility of the cured photoresist in the solvent composition, and wherein the solubility is computed according to a model of dispersion forces, dipolar forces, and hydrogen bonding between the solvent system and the cured photoresist.

11. The solvent composition of claim 10 wherein the model is a Hansen solubility parameter model.

12. The solvent composition of claim 11 wherein the parameters of the model include δD from 14 to 20, δP from 4 to 10, and δH from 7 to 15.

13. The solvent composition of claim 1 further comprising a corrosion inhibitor.

14. A solvent composition formulated to dissolve cured photoresist on a semiconductor surface, the solvent composition comprising:
about 1 to 30% by mass of monoethanolamine;
about 10 to 95% by mass of a mixture of ethylene glycol ethers comprising diethyleneglycol monobutylether (BDG) and diethyleneglycol monoethylether (EDG); and
about 1% by mass of N,N-diethylhydroxylamine (DEHA).

15. The solvent composition of claim 14 wherein the about 1 to 30% by mass comprises about 5% by mass, and the mixture comprises about 37% by mass BDG and about 56% by mass EDG.

16. A solvent composition formulated to dissolve cured photoresist on a semiconductor surface, the solvent composition comprising:
about 1 to 30% by mass of methyldiethanolamine;
about 10 to 95% by mass of a mixture of ethylene glycol ethers comprising diethyleneglycol monobutylether (BDG) and diethyleneglycol monoethylether (EDG); and
about 1% by mass of N,N-diethanolhydroxylamine.

17. The solvent composition of claim 16 wherein the about 1 to 30% by mass comprises about 5% by mass, and the mixture comprises about 37% by mass BDG and about 56% by mass EDG.

18. A solvent composition formulated to dissolve cured photoresist on a semiconductor surface, the solvent composition comprising:
about 5% by mass of methyldiethanolamine;
about 94% by mass of a mixture of ethylene glycol ethers comprising diethyleneglycol monobutylether (BDG) and diethyleneglycol monoethylether (EDG); and
about 1% by mass of N,N-diethylhydroxylamine.

19. The solvent composition of claim 18 wherein the mixture of ethylene glycol ethers comprises about 40% by mass of diethyleneglycol monobutylether (BDG) and about 60% by mass of diethyleneglycol monoethylether (EDG).
